(19) United States
(12) Patent Application Publication
(10) Pub. No.: US 2020/0114869 A1
(43) Pub. Date: Apr. 16, 2020

(54) WEBBING DESIGN THAT INDICATES THE TIGHTNESS LEVEL IN CHILD RESTRAINT SYSTEM INSTALLATION AND CARGO MOUNT

(71) Applicant: Collin Liyuan Wang, Farmington Hills, MI (US)

(72) Inventor: Collin Liyuan Wang, Farmington Hills, MI (US)

(21) Appl. No.: 16/159,591

(22) Filed: Oct. 12, 2018

(51) Int. Cl. B60R 22/48; B60N 2/26; B60P 7/08; B32B 7/12; B32B 7/08

(52) U.S. Cl. CPC B60R 22/48; B60N 2/265; B60R 2022/005; B32B 7/12; B32B 7/08; B60P 7/0823

(57) ABSTRACT

The present invention is comprised of a color changing device in the form of film or fabric that can be either integrated with a vehicle seatbelt or an add-on device that can be easily attached to the seatbelt. The color changing device will change its color when experiencing external stress. Different colors will indicate different external load applied to the seatbelt, which is used to determine if the seatbelt is properly tightened to secure a CRS. The invention can also be integrated into cargo mounting webbing to indicate webbing tightness used for securing and transporting cargo on trucks or other vehicles.

### TECHNICAL FIELD

The present invention relates generally to the Child Restraint System (CRS) installation in vehicle that reduces child injuries in automotive crash accidents and cargo mount.

### BACKGROUND OF THE INVENTION

A CRS is a seat or form designed specifically to protect children from injury or fatality during collisions in automotive vehicles or airplanes. Most commonly, these seats are purchased and installed by the consumers. Many jurisdictions require children that satisfy age, weight and/or height requirements to use government-approved child seats when riding a vehicle. Federal Motor Vehicle Safety Standard (FMVSS) 213 regulates the child seat requirements under crash conditions.

Even though regulations have been implemented to improve child safety, the CRS is misused as frequently as 72.6% of the time (Decina et al 2003). The misuse of a CRS can lead to a high or very high risk of sustaining severe injuries according to Lesire et al 2007 who studied 48 different misuse test configurations.

To properly install the CRS in a vehicle, ISOFix was implemented in the European Union and LATCH (Lower Anchorage and Tethers for Children) in the United States of America. These systems were regulated to improve the safety and reduce CRS installation errors in vehicle. Despite tremendous education efforts for more than a decade, CRS mis-installation still remains very high, and occurs up to 42% of the time according to a study by Greenwell et. al. in 2015.

### SUMMARY OF THE INVENTION

### Technical Problem

One major installation error is a lack of criteria to determine the tightness or tension of webbing when installing the CRS in vehicle. The differences between different individuals are very large and can create very different results in crash testing. It was shown that only 34 percent of parents have tightened CRS webbing correctly (Penmetsa et al 2007).

The most direct way to measure webbing tension is to integrate a force gauge into the webbing system. This technique is used in some professional labs for testing. There are a few recommended practices to quantify tension of the webbing. For example, a pull gage can be used to pull the webbing a certain distance from a contract surface and the gauge reading is used as an indicator for tension level although the exact tension is unknown. In the FMVSS 213 test protocol, a bar is used to pull the web, similar to the method mentioned above. This method can yield different tension between different CRS models due to the differences in webbing route, webbing length, webbing materials, webbing attachment methods.

The methods mentioned in [0006] require either a gauge that is integrated into the webbing by professionals or a special gage or tool. None of these methods are practicable for the parents who install their CRS on a daily basis. This patent is necessary as currently there does not exist a convenient system that does not require professional expertise to use for correctly measuring the tension in CRS webbing.

### Solutions to the Problem

This patent provides a design that can be integrated with vehicle seatbelt webbing to determine its tension when installing the CRS in vehicle. The design consists of a thin material, either in film or fabric like form, which changes color when stretched. The color change is related to the amount of force applied to the design.

The design can be used to indicate the tension level of the seatbelt webbing in a vehicle. The design can be integrated into the webbing by fastening the color changing material to the seatbelt webbing through techniques like, but not limited to, stitching, bonding with adhesive, or coating on the webbing directly. When the seatbelt webbing is tightened, the color change due to the stress applied to the webbing will indicate the proper tightness of the CRS. No other device or special tool is needed to measure the seatbelt webbing tension.

### ADVANTAGEOUS EFFECT OF THE INVENTION

The invention is advantageous since it does not require any other tools to indicate the tension level on the webbing.

Additionally, the invention's design can be easily integrated into an OEM's seatbelt design so that it is available to the vehicle owners directly.

The invention also has the advantage that an after-market product can be offered to the consumers and attached to existing vehicles.

### BRIEF DESCRIPTION OF DRAWINGS

FIG. 1 is view of this invention, a webbing with the color change device.

FIG. 2 is the perspective view of the child restraint system webbing with the color change device.

FIG. 3 is another perspective view of the child restraint system webbing with the color change device

FIG. 4 is the perspective view of the cargo mount webbing with the color change device.

### DESCRIPTION OF EMBODIMENT(S)

The embodiment described in this patent can be applied to a CRS to assist users in installing child seats properly in vehicles to maximize safety.

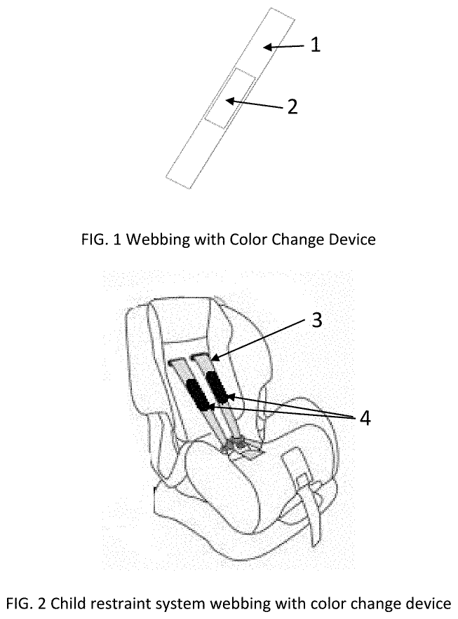

FIG. 1 shows this invention with two elements, the webbing indicated at 1, and the color change device that indicates the tension level at 2.

The invention can be applied to the child restraint system as illustrated in FIG. 2. The invention indicated at 4, can be applied to the webbing that restraints the child occupant in case of a vehicle crash accident.

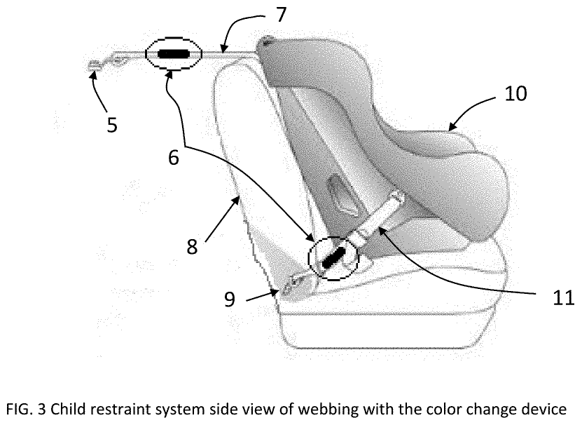

As illustrated in FIG. 3, mandated by FMVSS 213, the child restraint system 10 is required to be attached to the vehicle seat 8 at the lower anchor 9 with strap 11, and the top tether 7 to the top tether anchor 5 inside the vehicle.

The color change device 6 is attached to the webbing 7 and 11 to indicate how tight the child restraint system 10 is secured to the vehicle seat 8, see FIG. 3.

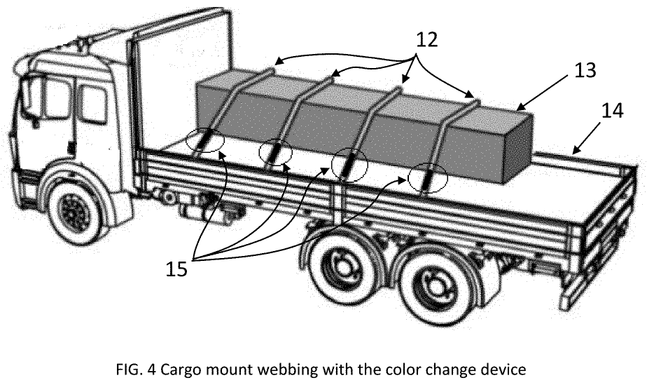

The embodiment can also be integrated into cargo webbing to assist truck drivers or loaders in tightening the webbing appropriately to ensure optimal cargo safety during transportation, shown in FIG. 4.

FIG. 4 illustrates the cargo mounting webbing. The platform of the cargo is 14. The cargo mounted is 13. The cargo mounting webbing 12 is used to secure the cargo to the vehicle. The color change device 15 is to indicated how tight the webbing is fastened to secure the cargo.

### CITATION LIST

Decina L. E., Lococo K. H. Misuse of Child Restraints, US Department of Transportation report, DOT HS 809 671, May 2003

Greenwell N. K. Results of National Child Restraint Use Special Study, US Department of Transportation Report, DOT HS 812 142, May 2015.

Lesire P., Cuny S., Alonzo F., Tejera G., Cataldi M. Misuse of child restraint systems in crash situation—danger and possible consequences. 51^{st} Annual Proceedings Association for the Advancement of Automotive Medicine, Oct. 15-17, 2007.

Penmetsa, P., Wang, T., Nambisan, S. S., 2018. An assessment of child restraint system misuse in United States. Transportation Research Board 97^{th} Annual Meeting, January 2018, Washington, DC.

What is claimed is:

1. A color change design in film or fabric form that changes colors due to external stress. The design is integrated with a child restraint system webbing comprised of a) color change device in the forms of film, fabric or a layer of material; b) webbing with the color change device integrated by embedding, mechanical attachment or adhesive method or combination of the two or three methods described here.

2. Color change device of claim 1 directly integrated with the child restraint system webbing.

3. Color change device of claim 1 that can be attached to the existing vehicle seatbelt with mechanical mechanism, bonding with adhesive, stitching, or other equivalent technique.

4. Color change device of claim 1 integrated with the cargo mounting webbing in trucks, automotive vehicles, airplanes, or trains.
